(19) United States
(12) Patent Application Publication
(10) Pub. No.: US 2014/0107932 A1
(43) Pub. Date: Apr. 17, 2014

(54) PLATFORM FOR PROVIDING WELLNESS ASSESSMENTS AND RECOMMENDATIONS USING SENSOR DATA

(71) Applicant: Michael Edward Smith Luna, San Jose, CA (US)

(72) Inventor: Michael Edward Smith Luna, San Jose, CA (US)

(73) Assignee: AliphCom, San Francisco, CA (US)

(21) Appl. No.: 13/830,860

(22) Filed: Mar. 14, 2013

Related U.S. Application Data
(60) Provisional application No. 61/712,645, filed on Oct. 11, 2012.

(51) Int. Cl. G01D 21/00

(52) U.S. Cl. CPC G01D 21/00
USPC 702/19

(57) ABSTRACT

Techniques associated with a platform for providing wellness assessments and recommendations using sensor data are described, including collecting local sensor data using a wearable device having a communication facility configured to connect to a network, accessing environmental data from third party databases, generating a wellness assessment using a rules based engine configured to process the local sensor data, the environmental data and historical user data, and generating a wellness recommendation using the wellness assessment.

### CROSS-REFERENCE TO RELATED APPLICATIONS

This application claims the benefit of U.S. Provisional Patent Application No. 61/712,645 (Attorney Docket No. ALI-152P), filed Oct. 11, 2012, which is incorporated by reference herein in its entirety for all purposes.

### FIELD

The present invention relates generally to electrical and electronic hardware, computer software, wired and wireless network communications, and computing devices. More specifically, techniques related to a platform for providing wellness assessments and recommendations using sensor data are described.

### BACKGROUND

Conventional devices and techniques for providing health assessments and recommendations using sensor data are limited in a number of ways. Conventional devices for capturing sensor data associated with a user's activity and physiological traits typically lack the ability to capture, analyze, communicate and use the data in a contextually-meaningful or comprehensive manner. Such conventional devices lack the capability to cross-correlate useful information available from public and private databases with local sensor data associated with a user to provide meaningful assessments and recommendations to improve a user's overall wellness (i.e., physical, mental and emotional health and well being).

While conventional techniques for garnering personal health recommendations are sometimes capable of accessing and analyzing information provided by a user, or collected from a user's mobile computing or communications devices, they are typically not well-suited to correlate, or cross-reference, such data with local sensor data (i.e., collected using a wearable sensor device) providing real-time information regarding a user's activities and physiological status. Such techniques also are not well-suited to provide a comprehensive wellness service that can account for a user's current and historical medical, lifestyle, and other wellness data, as well as to identify and cross-reference that data with relevant public information.

Thus, what is needed is a solution for providing wellness assessments and recommendations using sensor data without the limitations of conventional techniques.

### BRIEF DESCRIPTION OF THE DRAWINGS

Various embodiments or examples (“examples”) are disclosed in the following detailed description and the accompanying drawings:

FIG. 1A illustrates an exemplary system for providing a wellness assessment and recommendation using sensor data;

FIG. 1B illustrates an exemplary flow for generating a wellness assessment and recommendation;

FIG. 2 illustrates an exemplary graphical representation associated with a wellness assessment;

FIG. 3 illustrates an alternative exemplary graphical representation associated with a wellness assessment;

FIG. 4 illustrates another alternative exemplary graphical representation associated with a wellness assessment;

FIG. 5 illustrates still another alternative exemplary graphical representation associated with a wellness assessment

FIGS. 6A-6B illustrate another exemplary flow for generating a wellness assessment and recommendation; and

FIG. 7 illustrates an exemplary system and platform for providing wellness assessments and recommendations.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

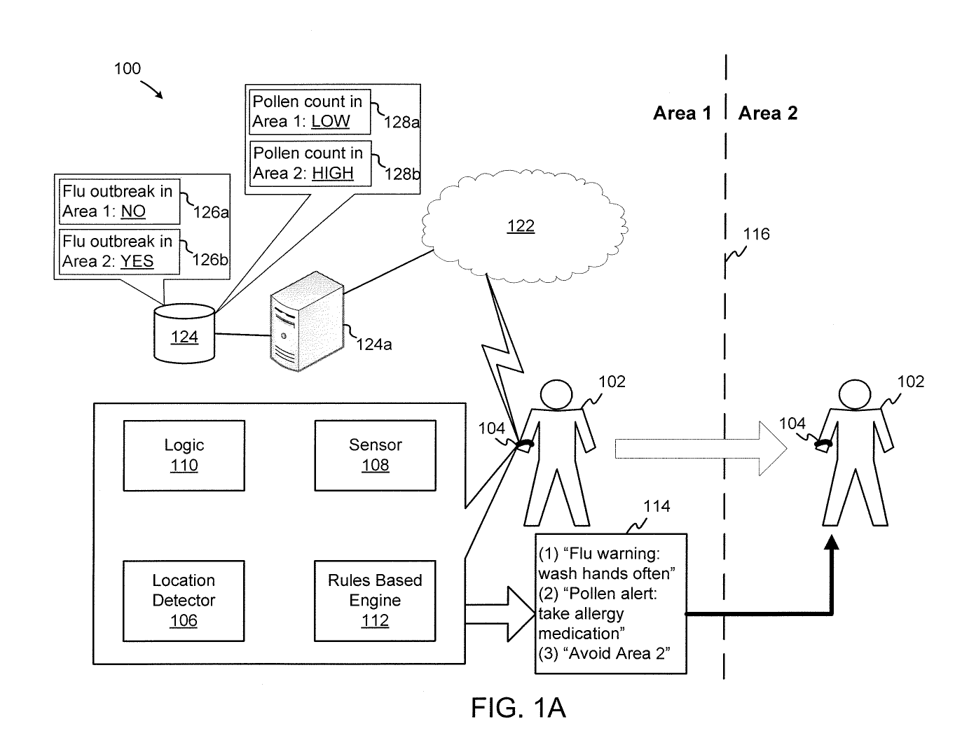

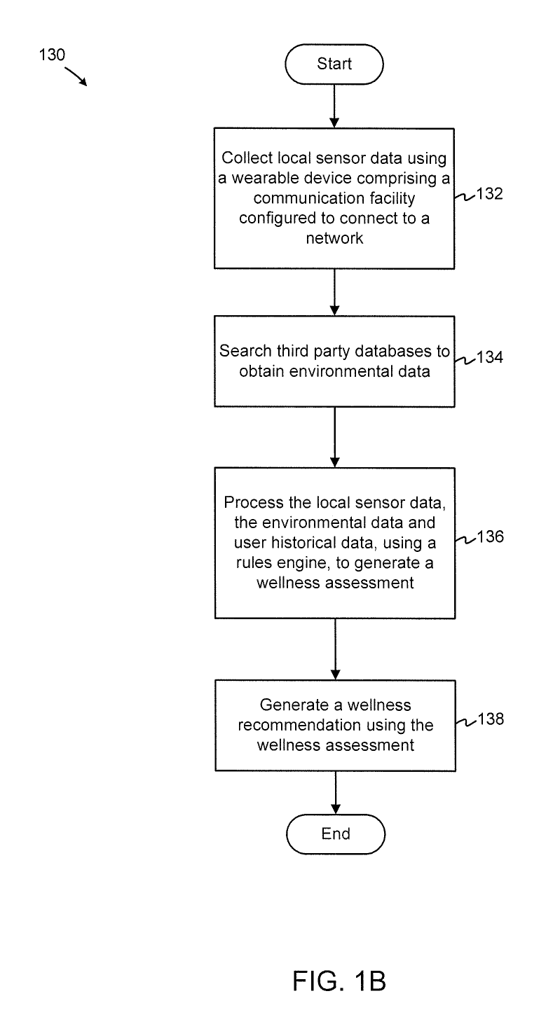

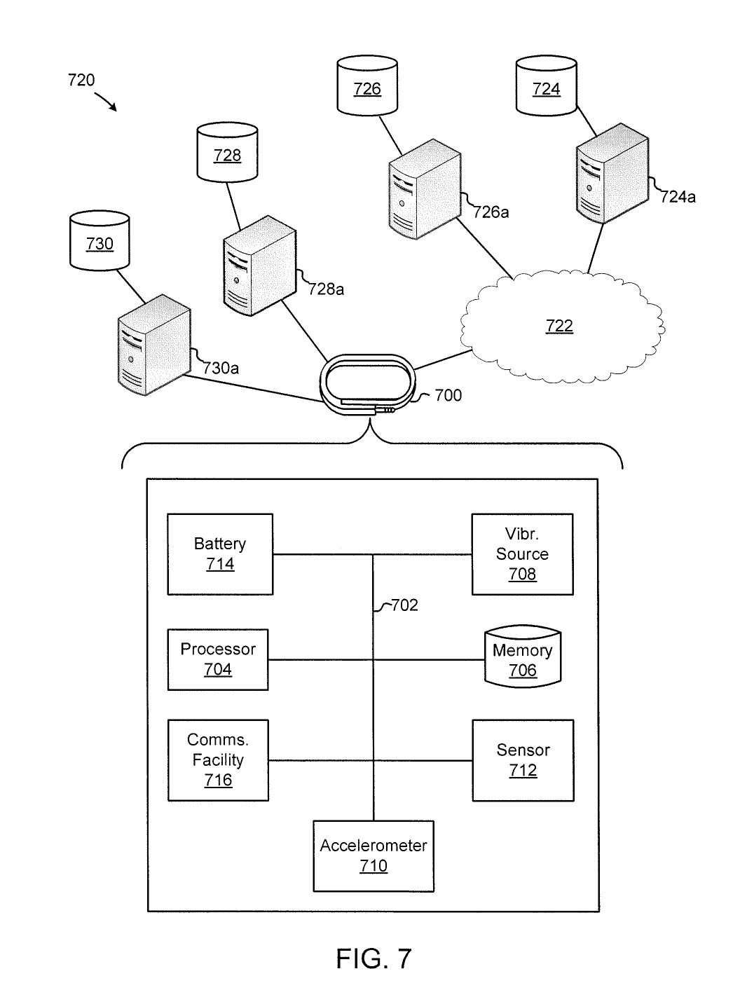

FIG. 1A illustrates an exemplary system for providing a wellness assessment and recommendation using sensor data. Here, system 100 includes person or user 102, wearable device 104 (shown to include location detector 106, sensor 108, logic 110 and rules based engine 112), message 114, border 116 between Area 1 and Area 2, network 127, database 124, server 124a, and data 126a-128b. In some examples, sensor 108 may include one or multiple sensors and is not intended to be limiting as to the quantity or type of sensor implemented. In some examples, database 124 may be implemented using server 124a, and may be managed by a database management system (“DBMS”). Database 124 also may be accessed (i.e., for searching, collecting and/or downloading data stored in database 124), for example by wearable device 104 (i.e., using a communication facility (e.g., communication facility 716 in FIG. 7), using network 122 (e.g., cloud, Internet, LAN, or the like). In some examples, database 124 may store various types of data, including data 126a-128b. For example, database 124 may store data 126a indicating there is no flu outbreak in Area 1, and also may store data 126b indicating that there is a flu outbreak in Area 2. In another example, database 124 also may store data 128a indicating there is a low pollen count in Area 1, and also may store data 128b indicating there is a high pollen count in Area 2. In other examples, the above-described elements may be varied in function, structure, configuration, or implementation and are not limited to those shown and described.

In some examples, logic 110 may be firmware or application software that is installed in a memory (e.g., memory 706 in FIG. 7) and executed by a processor (e.g., processor 704 in FIG. 7). Included in logic 110 may be program instructions or code source, object, binary executables, or others) that, when initiated, called, or instantiated, perform various functions. In some examples, logic 110 may provide control functions and signals to other components of wearable device 104, including to location detector 106, sensor 108, rules based engine 112, or other components. For example, logic 110 may be configured to send control signals to location detector 106 to transfer, transmit, or receive data, to and from rules based engine 112 or a memory (e.g., memory 706 in FIG. 7).

As shown, user 102 may be traveling from Area 1 to Area 2, distinguished by border 116. Area 1 and Area 2 may be any distinguishable geographical areas, locations, zones, or the like. For example, Area 1 may be one city and Area 2 another city; Area 1 may be one county and Area 2 another county; Area 1 may be a Tropic (or Torrid) Zone and Area 2 a Temperate Zone; Area 1 may be one wing of a building and Area 2 another wing; and so on. In some examples, wearable device 104 may be configured to detect user 102's current location in Area 1 using location detector 106, which may be implemented using a global positioning system (GPS) or other location detection services. In some examples, wearable device 104 also may be configured to detect user 102's movement toward, or in the direction of, Area 2, for example, using location detector 106 and sensor 108. In some examples, wearable device 104 may be configured to access data from various public and private databases (e.g., database 124, or databases 724-730 in FIG. 7) and to use that data to provide messages, alerts, warnings, or other information (hereafter, “message”) associated with a wellness assessment and/or wellness recommendation. For example, data associated with user 102's movement from Area 1 to Area 2 may be communicated to rules based engine 112, and may trigger rules based engine 112 to run a set of rules associated with the user and with Areas 1 and 2. For example, as described above, wearable device 104 may receive or download data from database 124 indicating that user 102 is moving from an area with no flu outbreak to an area with a flu outbreak, and also from an area with low pollen count to an area with high pollen count. In other examples, database 124, or other databases accessible by wearable device 104 (e.g., databases 724-730 in FIG. 7), may store data representing other information (e.g., air quality indexes, other weather-related information, or the like) that may be relevant to a user's wellness. In some examples, wearable device 104 also may store, access, or download information associated with user 102's medical history or other health information, for example, indicating that user 102 is prone to allergic reactions to pollen and takes an allergy medication for it, that user 102 has arthritis, or the like. In some examples rules based engine 112 may be configured to process some or all of this data to output processed data representing, or otherwise associated with, one or more wellness assessments. This data may then be used to determine one or more wellness recommendations, and to generate a message (e.g., message 114 or the like) to be delivered to user 102 upon or around the time of crossing from Area 1 to Area 2. In some examples, message 114 may include a single message, for example, of the highest priority or importance. In other examples, message 114 may include more than one message. In still other examples, multiple messages may be provided to user 102, in a prioritized list in message 114 or in a series of messages, for example in order of priority or importance. In some examples, message 114 (or other types of alerts and warnings) may be provided to user 102 using a display or other user interface implemented on wearable device 104. In other examples, message 114 may be provided to user 102 using a display or other user interface implemented on another device (e.g., a mobile computing device, a mobile communications device, a tablet computer, a laptop, or other computing or communications device). In other examples wearable device 104 and the above-described elements may be varied in function, structure, configuration, or implementation and are not limited to those shown and described

FIG. 1B illustrates an exemplary flow for generating a wellness assessment and recommendation. Here, flow 100 begins with collecting (i.e., receiving, gathering and storing) local sensor data using a wearable device having a communication facility configured to connect to a network (132). In some examples, a wearable device (e.g., wearable device 104, wearable device 700, or the like) may collect local sensor data using one or more sensors (e.g., accelerometer, altimeter/barometer, light/infrared (“IR”) sensor, pulse/heart rate (“HR”) monitor, audio sensor (e.g., microphone, transducer, or others), pedometer, velocimeter, global positioning system (GPS) receiver, location-based service sensor (e.g., sensor for determining location within a cellular or micro-cellular network, which may or may not use GPS or other satellite constellations for fixing a position), motion detection sensor, environmental sensor, chemical sensor, electrical sensor, or mechanical sensor, and the like) installed, integrated, or otherwise implemented on the wearable device. In other examples, a wearable device also may capture data from distributed sources (e.g., by communicating (i.e. using communication facility 716) with mobile computing devices, mobile communications devices, computers, laptops, distributed sensors, GPS satellites, or the like) for processing with sensor data. Environmental data also may be obtained by searching third party databases (134), for example, using a wearable device (e.g., wearable device 104 in FIG. 1A, wearable device 700 in FIG. 7, or the like). Environmental data may include data associated with a surrounding, or other relevant or chosen, environment (e.g., surrounding the wearable device, otherwise of interest to a user of a wearable device, or the like). For example, environmental data may include information associated with weather, local or seasonal produce, other location-based information, journal publications (e.g., health, medical, technological, environmental, or the like), news, other publications, astronomy, governmental guidelines (e.g., provided by the Food and Drug Administration (FDA), the Center for Disease Control (CDC), the Health Resources and Services Administration (HRSA), state health departments, National Weather Service, and the like) and other types of information that may be associated or correlated with a user's health and wellness. A third party database may include any database accessible using a network (e.g., cloud, Internet, LAN, or the like) to which a communication facility (e.g., communication facility 116) may connect.

Once environmental data is obtained, the local sensor data, environmental data may be processed optionally along with user historical data, using a rules based engine (e.g., stored in a memory (e.g., memory 706 in FIG. 7) and implemented using a processor (e.g., processor 704 in FIG. 7), to generate a wellness assessment (136). In some examples, user historical data may include local sensor data previously collected by a wearable device associated with a user. For example, user historical data may include the activity, sleeping, physiological and other patterns and information determined using local sensor data previously collected by a wearable device being worn by a user. For example, user historical data may include metrics correlating various types of sensor data (e.g., associating a user's bedtime with the user's quality of sleep, number of steps taken in a day to number of hours of sleep for the user that day, or the like) pre-calculated using local sensor data previously collected by the user's wearable device. Such metrics may provide insights into a user's pattern of behavior (e.g., whether there is a deviation from historical data that may be caused by, or correlated to, the environment, or the like), and such insights may be used in providing wellness assessments and recommendations. In another example, user historical data may include medical information (e.g., list of medications being taken, history of diseases, illnesses, ailments, surgeries, other procedures, and the like) provided by a user (e.g., uploaded into a private database, obtained from a user's medical provider, manually entered, or the like). In yet another example, user historical data may include wellness goats identified by a user (e.g., lose five pounds, run a mile in under ten minutes, eat healthier, eat gluten free, complete a triathlon, get better sleep, walk at least two miles every day, and the like). In still other examples, user historical data may be aggregated using sensor data previously collected by a plurality of wearable devices associated with a plurality of users. For example, user historical data also may include the activity, sleeping, physiological, biorhythmic and other patterns and information determined using previously collected sensor data aggregated from a wearable device being worn by a user in addition to other wearable devices being worn by other users e.g., a population, a subset of a population, or the like). In this example, user historical data may include metrics correlating various types of sensor data (e.g., associating aggregated (i.e., average, median or typical) activity level by a plurality of users with quality of steep for the plurality of users with an average number of hours of sleep per user on a given night (e.g., an equinox, a full moon, a hot day, a cold day, or the like) and/or in a given region (e.g., North America, Asia, East Coast, West Coast, an individual state, above or below a latitude, or the like)).

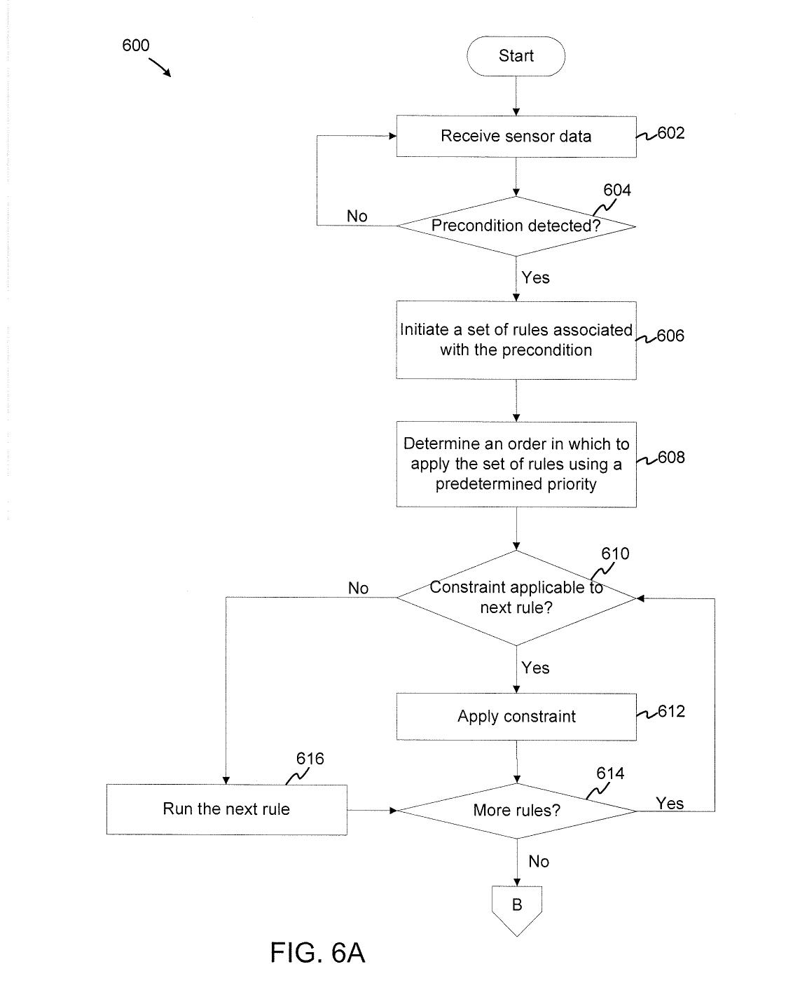

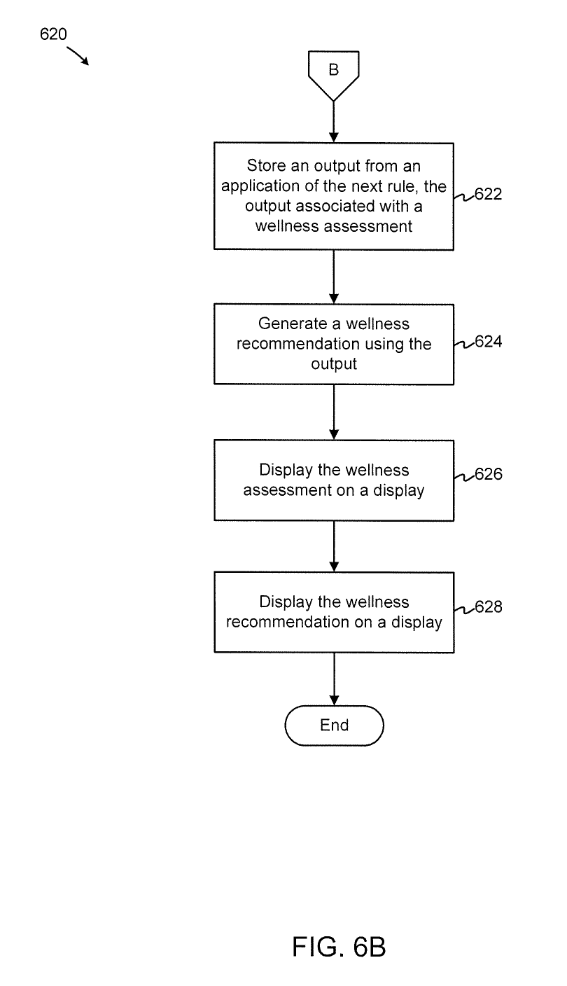

In some examples, the local sensor data may be run through a rules based engine (e.g., according to the flow of operation shown in FIGS. 6A-6B), which may be equipped to process the environmental data and user historical data to output a wellness assessment an assessment associated with a user's physical and mental health, longevity, performance levels, and the like). In an example, data representing a wellness assessment may indicate, based upon local sensor data, environmental data and user historical data, that a user's activity level is uncharacteristically low today, which the user's historical data indicates may impact the user's quality of sleep that day. In another example, data representing a wellness assessment may indicate, based upon local sensor data, environmental data and user historical data, that it will be a cold or humid day, which may cause a user's arthritis to flare. In still another example, a wellness assessment may indicate, based upon local sensor data, environmental data and user historical data, that a user is ill, for example, if a rise in body temperature and increase in heart rate and perspiration does not correspond with an increase in activity level, ambient temperature, or a pre-calculated biorhythm. In yet other examples, a wellness assessment may indicate a variety of other facts associated with a user's wellness using a combination of local sensor data, environmental data and user historical data. In some examples, a wellness assessment may be displayed on a wearable device (e.g., wearable device 104 in FIG. 1A, wearable device 700 in FIG. 7, or the like). In other examples, data representing a wellness assessment may be communicated to another device (e.g., mobile computing device, mobile communications device, computer, laptop, and the like) to be displayed.

In some examples, he wellness assessment may be used to generate a wellness recommendation (i.e., recommended action) (108). For example, a wellness assessment indicating that a user has taken an uncharacteristically low number of steps on a given day may result in a wellness recommendation prompting the user the take a walk or otherwise increase level of activity before the day ends. In another example, a wellness assessment indicating that a user has a fever may result in a wellness recommendation to take an over-the-counter medication to reduce the fever and/or to seek medical attention. In still another example, a wellness assessment indicating the anticipated weather may negatively impact a user's arthritis condition may result in a wellness recommendation to remain in a controlled indoor environment or to take other preventative measures. In yet other examples, various wellness recommendation may result from a variety of data associated with wellness assessments, as derived from a combination of local sensor data, environmental data and user historical data. In some examples, a rules based engine may be configured with rules associated with (i.e., customized using) user historical data and environmental data to output a prioritized list of wellness assessments and recommendations. For example, a rules based engine may be configured to account for a user's medical history (e.g., has heart condition, has high cholesterol, taking certain medications, and the like) and environmental data (e.g., current published studies on foods to combat heart disease, published guidelines for diets low in cholesterol, published guidelines for foods that conflict with certain medications, and the like), to eliminate and/or prioritize certain wellness assessments and recommendations. For example, while a certain food may he a suggested part of a diabetic diet, it may conflict with a user's medication, and thus be eliminated as a wellness recommendation for that user. In another example, local sensor data may result in a plurality of wellness assessments associated with a combination of diet, activity, and other recommendations.

Such wellness assessments and recommendations may be prioritized (i.e., ordered) according to criteria associated with user historical data and environmental data. For example, wellness assessments and recommendations associated with medications may take priority over assessments and recommendations associated with a weight goal. In other examples, wellness assessments and recommendations may be prioritized differently than described herein. In still other examples, the above-described process may be varied in the implementation, order, function, or structure of each or all steps and is not limited to those provided.

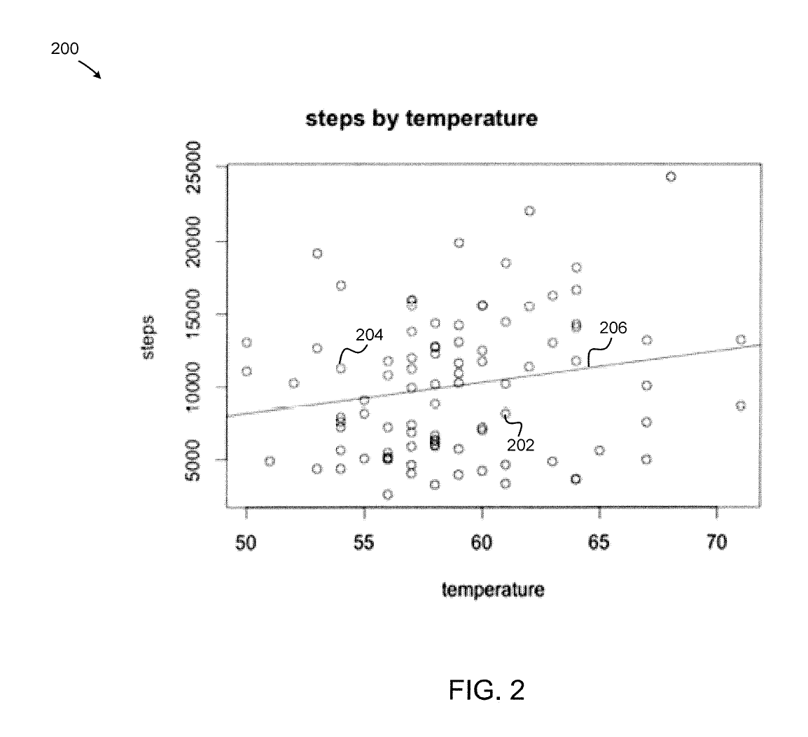

FIG. 2 illustrates an exemplary graphical representation associated with a wellness assessment. Here, graph 200 shows data points 202-204, and line 206. In some examples, data points 202-204, as well as the other data points shown on graph 200, indicate individual instances or occasions of steps taken at particular temperatures. For example, data point 202 indicates that a user walked approximately 11,000 steps on one occasion when it was approximately 54 degrees. In another example, data point 204 indicates that a user walked approximately 8,000 steps on another occasion when it was approximately 62 degrees. In some examples, such data may be aggregated over time to determine a trend (e.g., calculated using a mean, median, interpolation, extrapolation, or the like), for example, as represented by line 206, associated with a user's behavior. For example, line 206 may indicate an insight about the correlation between a user's activity and the weather, and in particular, that a user may take more steps when it is warmer. In some examples, graph 200 may represent a wellness assessment for (i.e., insight about or historical data associated with) a user indicating the user's activity level as compared with a range of ambient temperatures. In some examples, graph 200, and the data represented in graph 200, may be output from implementation of an algorithm, for example, using a rules based engine, as described herein. In some examples, graph 200 may be used to generate a wellness recommendation for a user, which also may be personalized according to a user's medical history, activity history, stated wellness goals, and other data (i.e., sensor, historical or environmental) associated with the user. In other examples, the data points shown in graph 200 may be aggregated from data collected from a plurality of users, for example, representing a trend across a particular demographic or other section of a population. In still other examples, a graphical representation associated with a wellness assessment may be implemented differently and is not limited to the examples provided.

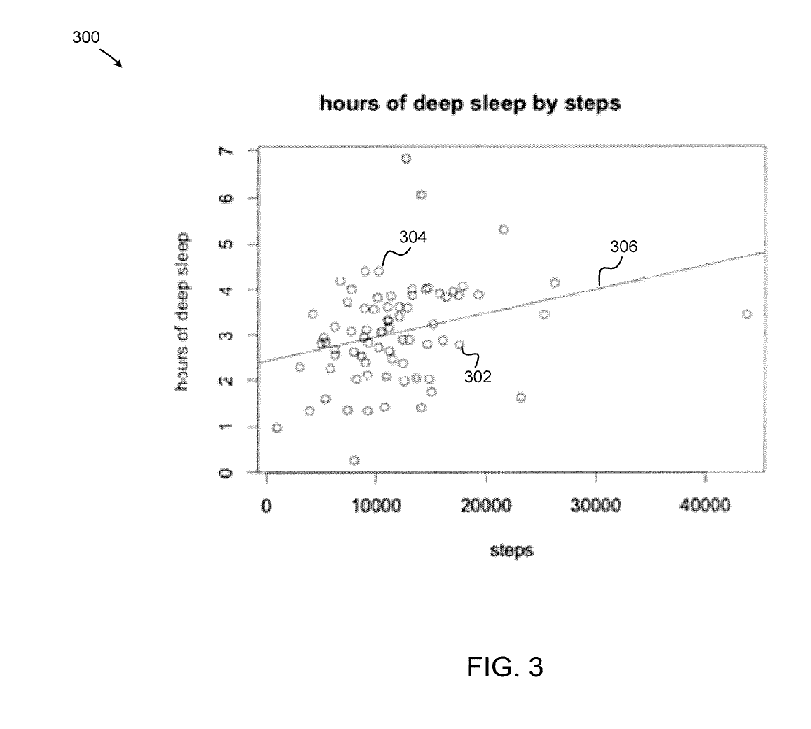

FIG. 3 illustrates an alternative exemplary graphical representation associated with a wellness assessment. Here, graph 300 shows data points 302-304, and line 306. Like-numbered and named elements may describe the same or substantially similar elements as those shown in other descriptions. In some examples, data points 302-304, as well as other data points shown on graph 300, correlate hours of deep steep with number of steps taken during a given day. Each data point (e.g., data points 302-304) represents a day and night For example, data point 302 indicates that on one day, a user took approximately 19,000 steps and experienced 2.5 hours of deep sleep. In another example, data point 304 indicates that on another day, a user took approximately 10,500 steps and experienced over 4 hours of deep sleep. In some examples, the data represented by the data points (e.g., data points 302-304) may be aggregated over time to determine a trend (e.g., as represented by line 306). In some examples, an insight about the correlation between a user's deep sleep and daily activity (i.e., number of steps taken that day) may be derived from the data represented by the data points (e.g., data points 302-304), for example, as represented by line 306. For example, line 306 may indicate that a user is likely to experience more hours of deep sleep after a day of greater activity (i.e., represented by the number of steps taken). In other examples, the data points shown in graph 300 may be aggregated from data collected from a plurality of users, for example, representing a trend across a particular demographic or other section of a population. In some examples, the insights or correlations shown in graph 300 may be used to generate a wellness recommendation for a user, for example, to suggest an additional number of steps to take per day to increase the number of hours of deep sleep the user may get every night. In other examples, a wellness recommendation may be personalized according to a user's medical history, activity history, stated wellness goals, and other data (i.e., sensor, historical or environmental) associated with the user. In still other examples, a graphical representation associated with a wellness assessment may be implemented differently and is not limited to the examples provided.

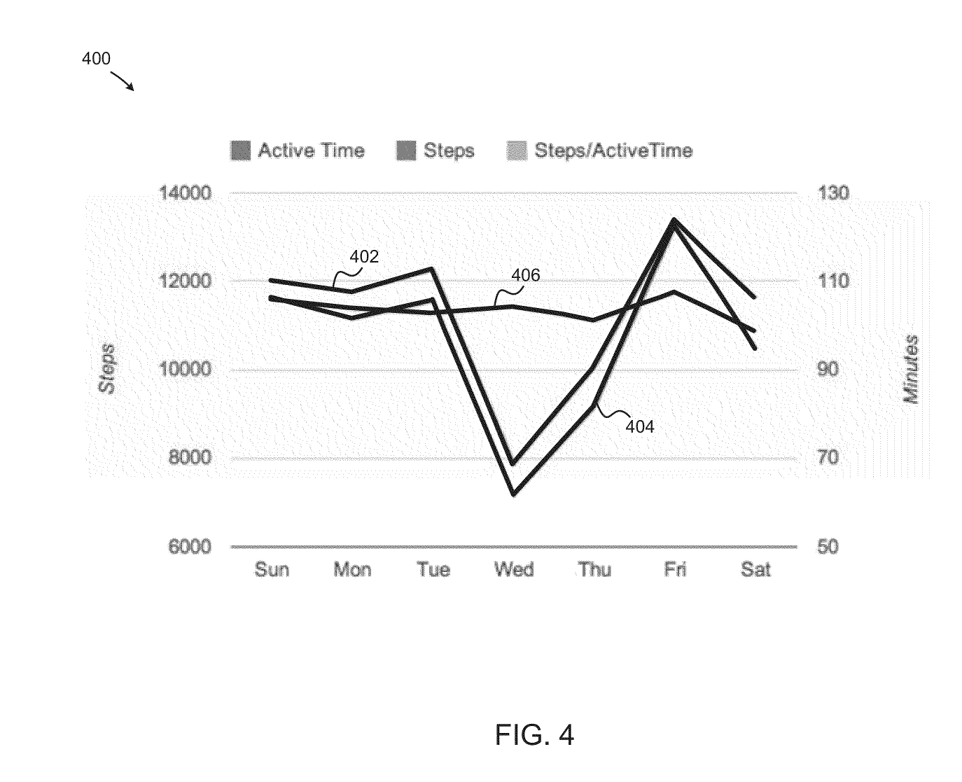

FIG. 4 illustrates another alternative exemplary graphical representation of a wellness assessment. Here, graph 400 shows lines 402-406. Like-numbered and named elements may describe the same or substantially similar elements as those shown in other descriptions. In some examples, line 402 may represent an amount of time (i.e., in minutes) that a user has been active during a given week, for example, indicating a dip in active time on Wednesday. Line 404 may represent an activity level (i.e., in number of steps) that a user takes across the given week, for example, indicating a dip in the number of steps taken on Wednesday. Line 406 may correlate the number of steps with the minutes of active time, for example, indicating that the amount of active time corresponds relatively evenly with the number of steps taken by this user throughout the week. In some examples, the insights or correlations shown in graph 400 may be used to generate a wellness recommendation for a user, for example, to suggest an added activity on Wednesdays to boost both active time and activity level. In other examples, a wellness recommendation may be personalized according to a user's medical history, activity history, stated wellness goals, and other data (i.e., sensor, historical or environmental) associated with the user. In some examples, the data shown in graph 400 may represent an aggregation of data over a period of time. In other examples, the data shown in graph 400 may be aggregated from data collected from a plurality of users. In still other examples, a graphical representation associated with a wellness assessment may be implemented differently and is not limited to the examples provided.

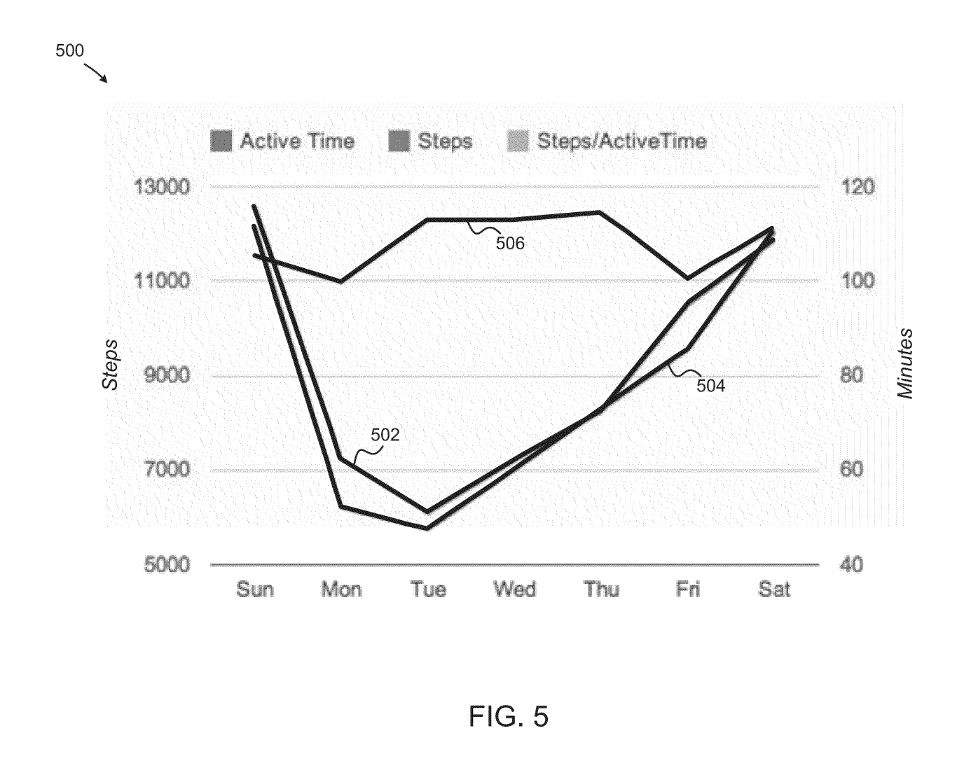

FIG. 5 illustrates still another alternative exemplary graphical representation of a wellness assessment. Here, graph 500 shows line 502-506. Like-numbered and named elements may describe the same or substantially similar elements as those shown in other descriptions. In some examples, line 502 may represent an amount of time in minutes) that a user has been active during a given week, for example, indicating this user is active twice as long on weekends as on weekdays. Line 504 may represent an activity level (i.e., in number of steps) that a user takes across the given week, for example, indicating this user's activity level on weekends is double what it is on weekdays. Line 506 may correlate the number of steps with the minutes of active time, for example, indicating that the amount of active time corresponds relatively evenly with the number of steps taken by this user throughout the week. In some examples, the insights or correlations shown in graph 500 may be used to generate a wellness recommendation for a user, for example, to suggest an added weekday activity to boost both active time and activity level during weekdays. In other examples, a wellness recommendation may be personalized according to a user's medical history, activity history, stated wellness goals, and other data (i.e., sensor, historical or environmental) associated with the user. In some examples, the data shown in graph 500 may represent an aggregation of data over a period of time. In other examples, the data shown in graph 500 may be aggregated from data collected from a plurality of users. In still other examples, a graphical representation associated with a wellness assessment may be implemented differently and is not limited to the examples provided.

FIGS. 6A-6B illustrate another exemplary flow for generating a wellness assessment and recommendation. Here, flow 600 begins with receiving sensor data (602), for example using a wearable device wearable device 104 in FIG. 1, wearable device 700 in FIG. 7, or the like). Then, a precondition is detected using the sensor data (604). In some examples, a precondition may be prerequisites for a rule or a set of rules (i.e., one or more rules, for example, associated with a precondition) to be implemented or applied (e.g., sensor data indicates a step count below 80% of a user's average step count, a user has woken in the midst of a deep steep cycle two nights in a row, or the like). Once a precondition is detected, a set of rules associated with the precondition may be initiated (606). Once a set of rules is identified as being associated with the precondition, an order in which to apply the set of rules is determined using a predetermined priority (608). Once the order is determined, a determination is made whether there is a constraint applicable to a next rule (610), for example, the next rule in the order of priority for the set of rules that has not yet been run. For example, if no rules have been run (i.e., fired or applied) yet, then the next rule is the first rule. If the first two rules have run, then the third rule is the next rule to be run, and so on. A constraint associated with a rule may be a reason or condition for canceling or (preventing the application of a rule (i.e., constraining a rule from being applied). For example, a constraint may include a maximum number of times a rule can be applied. If the rule has been run the maximum number of times, then such a constraint would prevent the rule from being run again. In another example, a constraint may indicate that a rule may not be run if another rule has been run previously. In still another example, a constraint may indicate that a certain period of time must elapse before a rule may be fired again. If a constraint is determined to be applicable to a next rule, then the constraint is applied (i.e., the rule is not run) (612), and a determination is made whether here are any more rules to run (614) (i.e., in the set of rules associated with a detected precondition). If it is determined that there are no constraints applicable to a next rule, then the next rule is run (616), and a determination is made whether there are any more rules to run (614).

If it is determined that there are no more rules to run, then the process continues to process 620, as shown in FIG. 6B. Once a set of rules is run, according to a priority and applicable constraints, an output is stored from an application of the next rule, the output associated with a wellness assessment (622). In some examples, the output may include a statement of one or more wellness assessments determined through application of a set of rules. In other examples, the output may include a graphical representation of one or more wellness assessments determined through application of a set of rules (see, e.g., FIGS. 2-5). Also, a wellness recommendation may be generated using the output (624). For example, if an output indicates that a user has experienced an uncharacteristically low number of hours of deep sleep, and correlates that lack of quality sleep with a lower activity level (i.e., fewer steps taken), the output or assessment may indicate that the user sleeps less on days in which the user is less active, and a wellness recommendation may be generated prompting the user to increase the user's activity level (e.g., go for a jog, take a walk, walk the dog, or the like). In this example, another wellness recommendation also may be generated suggesting that the user set an alert or alarm to sleep or wake at specified times. In another example, if an output indicates that it is time for a meal for a user that is diabetic and taking certain medications, a wellness recommendation may be generated prompting the user to avoid certain foods. In this example, another wellness recommendation also may be generated suggesting nearby restaurants with menu items appropriate for the user's diet. In some examples, the wellness recommendation may be tailored or customized to a user according to the user's historical data (e.g., medical history, wellness goals, and the like), as well as environmental data associated with the user's historical data. In some examples, the wellness assessment may be displayed on a display (626) implemented on a wearable device (e.g., wearable device 104 in FIG. 1, wearable device 700 in FIG. 7, or the like) or on another device (e.g., mobile computing device, mobile communications device, computer, laptop, and the like). In some examples, the wellness recommendation also may be displayed on a display (628) implemented on a wearable device or another device. In other examples, the above-described process may be varied in the implementation, order, function, or structure of each or all steps and is not limited to those provided.

FIG. 7 illustrates an exemplary system and platform for providing health assessments and recommendations. Here, system 720 includes wearable device 700 (including bus 702, processor 704, memory 706, vibration source 708, accelerometer 710, sensor 712, battery 714, and communications facility 716), network 722, servers 724a-730a and databases 724-730. In some examples, the quantity, type, function, structure, and configuration of wearable device 700 and its elements e.g., bus 702, processor 704, memory 706, vibration source 708, accelerometer 710, sensor 712, battery 714, and communications facility 716) shown may be varied and are not limited to the examples provided. As shown, processor 704 may be implemented as logic to provide control functions and signals to memory 706, vibration source 708, accelerometer 710, sensor 712, battery 714, and communications facility 716. Processor 704 may be implemented using any type of processor or microprocessor suitable for packaging within wearable device 700. Various types of microprocessors may be used to provide data processing capabilities for wearable device 700 and are not limited to any specific type or capability. For example, a MSP430F5528-type microprocessor manufactured by Texas Instruments of Dallas, Tex. may be configured for data communication using audio tones and enabling the use of an audio plug-and-jack system (e.g., TRRS, TRS, or others) for transferring data captured by wearable device 700. Further, different processors may be desired if other functionality (e.g., the type and number of sensors (e.g., sensor 712)) are varied. Data processed by processor 704 may be stored using, for example, memory 706. In other examples, data processed by processor 704 also may be stored in a database, repository, or other storage medium not shown on wearable device 700, with which wearable device may communicate such data using communications facility 716.

In some examples, memory 706 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Memory 706 may also be implemented using one or more partitions that are configured for multiple types of data storage technologies to allow for non-modifiable (i.e., by a user) software to be installed (e.g., firmware installed on ROM) while also providing for storage of captured data and applications using, for example, RAM. Once captured and/or stored in memory 706, data may be subjected to various operations performed by other elements of wearable device 700.

Vibration source 708, in some examples, may be implemented as a motor or other mechanical structure that functions to provide vibratory energy that is communicated through wearable device 700. As an example, an application stored on memory 706 may be configured to monitor a clock signal from processor 704 in order to provide timekeeping functions to wearable device 700. If an alarm is set for a desired time, vibration source 708 may be used to vibrate when the desired time occurs. As another example, vibration source 708 may be coupled to a framework (not shown) or other structure that is used to translate or communicate vibratory energy throughout the physical structure of wearable device 700. In other examples, vibration source 708 may be implemented differently.

Power may be stored in battery 714, which may be implemented as a battery, battery module, power management module, or the like. Power may also be gathered from local power sources such as solar panels, thermo-electric generators, and kinetic energy generators, among others that are alternatives power sources to external power for a battery. These additional sources can either power the system directly or can charge a battery, which, in turn, is used to power the system (e.g., of a wearable device). In other words, battery 714 may include a rechargeable, expendable, replaceable, or other type of battery, but also circuitry, hardware, or software that may be used in connection with in lieu of processor 704 in order to provide power management, charge/recharging, sleep, or other functions. Further, battery 714 may be implemented using various types of battery technologies, including Lithium lion (“LI”), Nickel Metal Hydride (“NiMH”), or others, without limitation. Power drawn as electrical current may be distributed from battery via bus 702, the latter of which may be implemented as deposited or formed circuitry or using other forms of circuits or cabling, including flexible circuitry. Electrical current distributed from battery 714 and managed by processor 704 may be used by one or more of memory 706, vibration source 708, accelerometer 710, sensor 712, or communications facility 716.

As shown, various sensors may be used as input sources for data captured by wearable device 700. For example, accelerometer 710 may be used to detect a motion or other condition and convert it to data as measured across one, two, or three axes of motion. In addition to accelerometer 710, other sensors (i.e., sensor 712) may be implemented to provide temperature, environmental, physical, chemical, electrical, or other types of sensory inputs. As presented here, sensor 712 may include one or multiple sensors and is not intended to be limiting as to the quantity or type of sensor implemented. For example, sensor 712 may be configured to sense, detect, gather, or otherwise receive input (i.e., sensed physical, chemical, biological, physiological, or psychological quantities) that, once received, may be converted into data and transferred to processor 704 using bus 702. As an example, temperature, heart rate, respiration rate, galvanic skin response (i.e., skin conductance response), muscle stiffness/fatigue, and other types of conditions or parameters may be measured using sensor 712, which may be implemented using one or multiple sensors. Further, sensor 712 is generally coupled (directly or indirectly) to wearable device 700. As used herein, “coupled” may refer to a sensor being locally implemented on wearable device 700 or remotely on, for example, another device that is in data communication with it.

Sensor 712 may be configured, in some examples, to sense various types of environmental (e.g., ambient air temperature, barometric pressure, location (e.g., using GPS or other satellite constellations for calculating Cartesian or other coordinates on the earth's surface, micro-cell network triangulation, or others), physical, physiological, psychological, or activity-based conditions in order to determine a state of a user of wearable device 700. In other examples, applications or firmware may be downloaded that, when installed, may be configured to change sensor 712 in terms of function. Sensory input to sensor 712 may be used for various purposes such as measuring caloric burn rate, providing active (e.g., generating an alert such as vibration, audible, or visual indicator) or inactive (e.g., providing information, content, promotions, advertisements, or the like on a website, mobile website, or other location that is accessible using an account that is associated with a user and wearable device 700) feedback, measuring fatigue (e.g., by calculating skin conductance response (hereafter “SCR”) using sensor 712 or accelerometer 710) or other physical states, determining a mood of a user, and others, without limitation. As used herein, feedback may be provided using a mechanism (i.e., feedback mechanism) that is configured to provide an alert or other indicator to a user. Various types of feedback mechanisms may be used, including a vibratory source (e.g., vibration source 708), motor, light source (e.g., pulsating, blinking, or steady illumination), light emitting diode (LED), audible, audio, visual, haptic, or others, without limitation. Feedback mechanisms may provide sensory output of the types indicated above via wearable device 700 or, in other examples using other devices that may be in data communication with it. For example, a driver may receive a vibratory alert from vibration source (e.g., motor) 708 when sensor 712 detects skin tautness (using, for example, accelerometer to detect muscle stiffness) that indicates she is falling asleep and, in connection with a GPS-sensed signal, wearable device 720 determines that a vehicle is approaching a divider, intersection, obstacle, or is accelerating/decelerating rapidly, and the like. Further, an audible indicator may be generated and sent to an ear-worn communication device such as a Bluetooth® (or other data communication protocol, near or far field) headset. Other types of devices that have a data connection with wearable device 720 (i.e., using communications facility 716) may also be used to provide sensory output to a user, such as using a mobile communications or computing device having a graphical user interface to display data or information associated with sensory input received by sensor 712.

In some examples, sensory output may be an audible tone, visual indication, vibration, or other indicator that can be provided by another device that is in data communication with wearable device 700. In other examples, sensory output may be a media file such as a song that is played when sensor 712 detects a given parameter. For example, if a user is running and sensor 712 detects a heart rate that is lower than the recorded heart rate as measured against previous runs, processor 704 may be configured to generate a control signal to an audio device that begins playing an upbeat or high tempo song to the user in order to increase her heart rate and activity-based performance.

As another example, sensor 712 and/or accelerometer 710 may sense various inputs that can be measured against a calculated representation of a user's health or wellness, or a “lifeline” (e.g., LIFELINE™). If sensory input to sensor 712 (or accelerometer 710 or any other sensor implemented with wearable device 700) is received, it may be compared to the user's lifeline or other abstract representation (hereafter “representation”) in order to determine whether feedback, if any, should be provided in order to modify the user's behavior. A user may input a range of tolerance (i.e., a range within which an alert is not generated) or processor 704 may determine a range of tolerance to be stored in memory 706 with regard to various sensory input. For example, if sensor 712 is configured to measure internal bodily temperature, a user may seta 0.1 degree Fahrenheit range of tolerance to allow her body temperature to fluctuate between 98.5 and 98.7 degrees Fahrenheit before an alert is generated (e.g., to avoid heat stress, heat exhaustion, heat stroke, or the like). Sensor 712 may also be implemented as multiple sensors that are disposed (i.e., positioned) on opposite sides of wearable device 700 such that, when worn on a wrist or other bodily appendage, allows for the measurement of skin conductivity in order to determine skin conductance response. Skin conductivity may be used to measure various types of parameters and conditions such as cognitive effort, arousal, lying, stress, physical fatigue due to poor sleep quality, emotional responses to various stimuli, and others.

Sensory input captured by wearable device 700 using accelerometer 710 and sensor 712 or data requested from another source (i.e., outside of wearable device 700) may also be converted to data and exchanged, transferred, or otherwise communicated using communications facility 716. As used herein, “facility” refers to any, some, or all of the features and structures that are used to implement a given set of functions. For example, communications facility 716 may include a wireless radio, control circuit or logic, antenna, transceiver, receiver, transmitter, resistors, diodes, transistors, or other elements that are used to transmit and receive data from wearable device 700. In some examples, communications facility 716 may be implemented to provide a “wired” data communication capability such as an analog or digital attachment, plug, jack, or the like to allow for data to be transferred. In other examples, communications facility 716 may be implemented to provide a wireless data communication capability to transmit digitally encoded data across one or more frequencies using various types of data communication protocols (e.g., Bluetooth®, WiFi, Ultra-Wideband, Near Field Communications (NFC), or the like), without limitation. In some examples, communications facility 716 may communicate with a network (e.g., cloud, Internet, local area network (LAN), or the like), wired or wirelessly, to access information stored apart from wearable device 700. In still other examples, wearable device 700 and the above-described elements may be varied in function, structure, configuration, or implementation and are not limited to those shown and described.

As used herein, various types of indicators audible, visual, mechanical, or the like) may also be used in order to provide a sensory user interface. In other words, wearable device 700 may be configured with switch (not shown) that can be implemented using various types of structures as indicators of device state, function, operation, mode, or other conditions or characteristics. Examples of indicators include “wheel” or rotating structures such as dials or buttons that, when turned to a given position, indicate a particular function, mode, or state of wearable device 700. Other structures may include single or multiple-position switches that, when turned to a given position, are also configured for the user to visually recognize a function, mode, or state of wearable device 700. For example, a 4-position switch or button may indicate “on,” “off,” standby,” “active,” “inactive,” or other mode. A 2-position switch or button may also indicate other modes of operation such as “on” and “off”. As yet another example, a single switch or button may be provided such that, when the switch or button is depressed, wearable device 700 changes mode or function without, alternatively, providing a visual indication. In other examples, different types of buttons, switches, or other user interfaces may be provided and are not limited to the examples shown. Further, the quantity, type, function, structure, and configuration of wearable device 700 and the elements (e.g., bus 702, processor 704, memory 706, vibration source 708, accelerometer 710, sensor 712, battery 714, and communications facility 716) shown may be varied and are not limited to the examples provided.

In some examples, wearable device 700 may access data from databases 724-730 (i.e., implemented in servers 724a-730a) using communication facility 716, using wired or wireless communication methods. In some examples, wearable device 700 may obtain data (i.e., environmental data) from public databases 724-726 (e.g., storing information about weather, local or seasonal produce, other location-based information, journal publications (e.g., health, medical, technological, environmental, or the like), news, other publications, astronomy, governmental guidelines (e.g., provided by the FDA, CDC, HRSA, state health departments, and the like) and other types of information that may be associated or correlated with a user's health and wellness) accessible using network 722. In some examples, wearable device 700 may obtain data (i.e., user historical data) from private databases 728-730 (e.g., aggregating information about a plurality of users, information across various demographics or other sections of a population, and the like), either directly or through a secure network (not shown). In some examples, databases 724-330 may be implemented using servers 724a-730a. In some examples, servers 724a-730a may be implemented using one or more processor-based computing devices or networks, including computing clouds, storage area networks (SAN), or the like. In other examples, the quantity, type, function, structure, and configuration of the elements shown may be varied and are not limited to the examples provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
collecting local sensor data using a wearable device comprising a communication facility configured to connect to a network;
accessing environmental data from a plurality of third party databases;
generating a wellness assessment using a rules based engine configured to process the local sensor data, the environmental data and historical user data; and
generating a wellness recommendation using the wellness assessment.

2. The method of claim 1, wherein generating a wellness assessment using a rules based engine comprises detecting a precondition associated with a rule.

3. The method of claim 1, wherein generating a wellness assessment using a rules based engine comprises initiating a set of rules associated with a detected precondition.

4. The method of claim 1, wherein generating a wellness assessment using a rules based engine comprises determining an order in which to apply a set of rules.

5. The method of claim 1, wherein generating a wellness assessment using a rules based engine comprises determining whether a constraint is associated with a rule prior to applying the rule.

6. The method of claim 1, wherein generating a wellness assessment using a rules based engine comprises applying a set of rules in an order of priority.

7. The method of claim 1, wherein the local sensor data comprises location data.

8. The method of claim 1, wherein the local sensor data indicates a user's movement from one area to another area.

9. The method of claim 1, wherein the plurality of third party databases comprises a public database.

10. The method of claim 1, wherein the plurality of third party databases comprises a private database configured to be accessed by the wearable device.

11. The method of claim 1, wherein the local sensor data comprises a characteristic activity level.

12. The method of claim 1, wherein the environmental data indicates a disease outbreak in a geographical area.

13. The method of claim 1, wherein the environmental data indicates air quality in a geographical area.

14. The method of claim 1, wherein the environmental data is associated with weather.

15. A system, comprising:
a wearable device comprising one or more sensors configured to collect local sensor data;
a memory configured to store historical user data; and
a processor configured to access environmental data from a plurality of third party databases, to process the local sensor data, the environmental data and the historical user data using a rules based engine to generate a wellness assessment, and to generate a wellness recommendation using the wellness assessment.

16. The system of claim 15, further comprising a display configured to present the wellness assessment.

17. The system of claim 15, further comprising a user interface configured to present the wellness recommendation.

18. The system of claim 15, wherein the wellness assessment is configured to be presented using a graph.

19. The system of claim 15, wherein the wellness assessment is configured to correlate the local sensor data with a trend associated with a section of a population.

20. The system of claim 15, wherein the wellness assessment is configured to correlate the local sensor data with an aspect of the historical user data.
